(19) United States
(12) Patent Application Publication
(10) Pub. No.: US 2024/0221213 A1
(43) Pub. Date: Jul. 4, 2024

(54) SENSING DEVICE AND METHOD FOR SENSING A FILL LEVEL OF A SPACE, AND ELEVATOR INCLUDING THE SAME

(71) Applicants: KONE Elevators Co. LTD, Kunshan Jiangsu (CN); KONE CORPORATION, Helsinki (FI)

(72) Inventors: Yong Qing Lu, Kunshan (CN); Bin Xiao, Kunshan (CN); Qi Deng, Kunshan (CN); Chunwei Chang, Kunshan (CN); Tao Ye, Kunshan (CN)

(73) Assignees: KONE Elevators Co. LTD, Kunshan Jiangsu (CN); KONE CORPORATION, Helsinki (FI)

(21) Appl. No.: 18/403,354

(22) Filed: Jan. 3, 2024

(30) Foreign Application Priority Data
Jan. 4, 2023 (CN) 202310008489.6

(51) Int. Cl. G06T 7/73; B66B 5/00; G06V 10/46

(52) U.S. Cl. CPC G06T 7/74; B66B 5/0012; G06V 10/46; G06T 2207/30204; G06T 2207/30242

(57) ABSTRACT

A sensor for sensing a fill level of a space includes a housing, a circuit board, a camera, a distance measuring sensor and a controller. The controller is in communication connection with the camera and the distance measuring sensor to calculate the fill level of a space according to the input from the camera and the distance measuring sensor. An elevator includes the sensor for sensing the fill level of the elevator car space. A method for sensing and determining a fill level of a space like an elevator car without utilizing the gravity load can better identify the objects in the space and further calculate the fill level of the space according to the identified images, and can be used as a substitute or a beneficial supplement for gravity load determination.

### TECHNICAL FIELD

The disclosure relates to a sensing device and a method for sensing a fill level of a space. The disclosure also relates to an elevator comprising the sensing device.

### BACKGROUND

Usually, in a limited space like an elevator, it is often necessary to determine whether the space is full, so as to control the number of objects (including people or other creatures). A common method for determining the full-loading of the space is to detect the occupancy of the space by detecting the weight of the loads in the space. However, in some cases, the loads weighing device will not trigger a full-loading bypass, as the ground space of this space may be occupied by lighter objects, such as occupants carrying large luggages or strollers.

Therefore, in this case, it is desired to sense the fill level of the space (elevator car) through devices and methods based on a non-weight detection.

### SUMMARY

In view of the problems and demands mentioned above, the present disclosure proposes a new technical scheme, which solves the above problems and brings other technical effects by adopting the following technical features.

According to the principle of the present disclosure, a device is installed in such a space as the elevator car to detect the fill level of the elevator car. When the car's fill level reaches a predefined threshold, a bypass signal will be triggered, and even though there is a landing call (from outside the car), the elevator will not serve a certain floor, because this may lead to unnecessary stop. In this case, another elevator can be assigned to receive the landing call, thus reducing the travel time of passengers in the elevator and the waiting time for passengers to make the landing call.

Therefore, the present disclosure provides a sensor for sensing a fill level of a space, which comprises: a housing, a circuit board, provided in the housing; a camera, connecting to the circuit board; a distance measuring sensor, connecting to the circuit board; wherein the controller is provided on the circuit board and is in communication connection with the camera and the distance measuring sensor to calculate the fill level of the space according to the input from the camera and the distance measuring sensor; wherein the camera and the distance measuring sensor are arranged to be exposed to the space.

The disclosure also provides an elevator, which comprises the aforementioned sensor for sensing the fill level of the elevator car space.

The disclosure also provides a method for sensing a fill level of a space, comprising:
step S1, obtaining a real-time ground image of the current space through a camera;
step S2, comparing the real-time ground image with a ground reference image, and calculating the image difference between the real-time ground image and the ground reference image;
step S3, converting the image difference into a binary image, and calculating ratios of specified pixels to all ground pixels in the binary image;
step S4, outputting a fill level of the space corresponding to the ratios.

To sum up, the present disclosure provides a method for determining the fill level of a space like an elevator car without utilizing the gravity load, and the method can better identify the objects in the space and further calculate the fill level of the space according to the identified images, and can be used as a substitute or a beneficial supplement for gravity load determination.

### BRIEF DESCRIPTION OF DRAWINGS

FIGS. 1-2 are schematic views of a sensing device for detecting a fill level of a space according to a preferred embodiment of the present disclosure;

FIG. 3 is a schematic diagram of main steps of a method for sensing a fill level of a space according to a preferred embodiment of the present disclosure;

FIG. 4 is a schematic diagram of a preferred process for calculating the image difference between a real-time ground image and a ground reference image;

FIG. 5A is a schematic diagram of setting markers at characteristic positions on the ground;

FIG. 5B is a schematic diagram of a preferred process of setting and processing markers;

FIG. 6 is a schematic diagram of a preferred process of a binary ground mask and a ground mask shape conforming to the actual shape of the floor;

FIG. 7 is a schematic diagram of a preferred process for obtaining a corrected ground mask image by verification;

FIG. 8 is a schematic diagram of a preferred process of modifying the ground image without markers according to the modified ground mask image to obtain a ground reference image;

FIG. 9 is a ground reference image obtained by the initialization process of the ground reference image according to the preferred embodiment of the present disclosure.

### DETAILED DESCRIPTION

In order to make the purpose, technical solution and advantages of the technical solution of the present disclosure clearer, the technical solution of the embodiment of the present disclosure will be described clearly and completely in the following with the attached drawings of specific embodiments of the present disclosure. Like reference numerals in the drawings represent like components. It should be noted that a described embodiment is a part of the embodiments of the present disclosure, not the whole embodiments. Based on the described embodiments of the present disclosure, all other embodiments obtained by those skilled in the field without creative labor fall into the scope of protection of the present disclosure.

In comparison with the embodiments shown in the attached drawings, feasible embodiments within the protection scope of the present disclosure may have fewer components, other components not shown in the attached drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by those skilled in the field to which this disclosure belongs. The terms “first”, “second” and similar terms used in the specification and claims of the patent application of this disclosure do not indicate any order, quantity or importance, but are only used to distinguish different components. When the number of components is not specified, the number of components can be one or more. Similarly, terms such as “a/an”, “the” and “said” do not necessarily mean quantity limitation. Similar terms such as “including” or “comprising” mean that the elements or objects appearing before the terms cover the elements or objects listed after the terms and their equivalents, without excluding other elements or objects. Similar terms such as “installation”, “setting”, “connection” or “matching” are not limited to physical or mechanical installation, setting and connection, but can include electrical installation, setting and connection, whether directly or indirectly. “Up”, “down”, “left” and “right” are only used to indicate the relative orientation relationship when the equipment is used or the orientation relationship shown in the attached drawings. When the absolute position of the described object changes, the relative orientation relationship may also change accordingly.

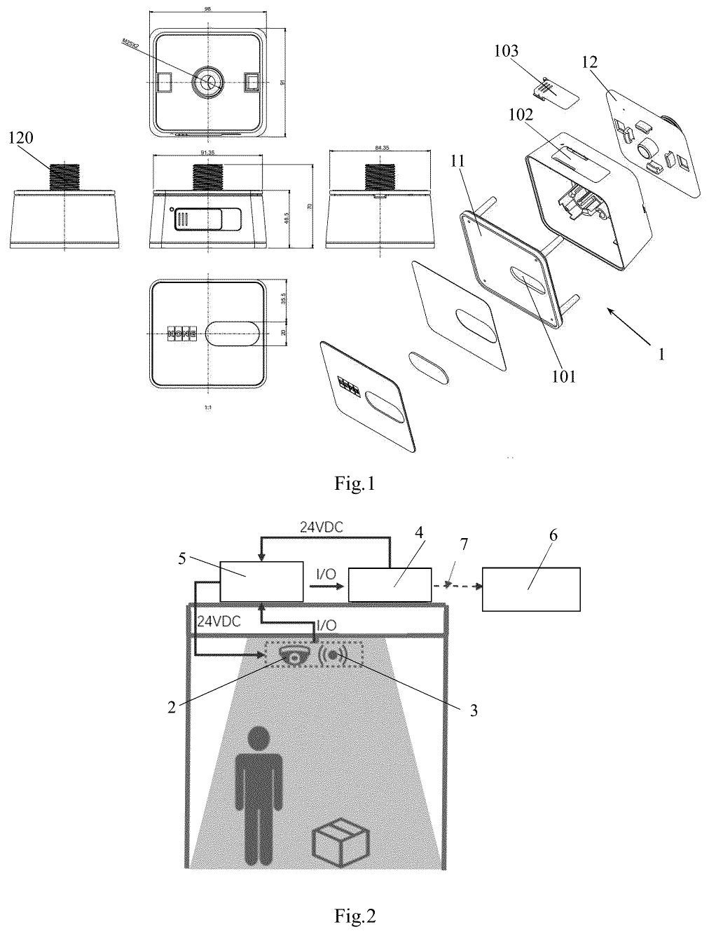

Referring to FIGS. 1 and 2, the present disclosure proposes a sensing device for sensing a fill level of a space, wherein FIG. 1 is an exploded view of the sensing device according to a preferred embodiment of the present disclosure, and FIG. 2 is a schematic diagram of a typical application of the sensing device according to a preferred embodiment of the present disclosure.

The sensing device mainly comprises: a housing 1; a circuit board (not specifically shown) provided in the housing 1; a camera 2 provided on the circuit board; a distance measuring sensor 3 provided on the circuit board; a controller (not shown in detail), provided on the circuit board and in communication connection with the camera and the distance measuring sensor. The camera and the distance measuring sensor are arranged to be exposed to the space, for example, they can be exposed through a same opening (such as the first opening 101 described later), or they can be exposed through different openings, so that the lens of the camera and the sensing means of the distance measuring sensor can obtain relevant images and signals (as described later) through the opening and input the same to the controller, to perform a calculation of the fill level of the space.

It should be understood that the camera and the distance measuring sensor can be connected with the circuit board in various flexible ways (including physical connection and electrical connection); for example, they can be directly installed on the circuit board, or on separate or shared brackets provided respecitively for the camera and the distance measuring sensor, and then connected with the circuit board and its controller through wires. The distance measuring sensor may be, for example, a typical TOF sensor based on laser, microwave, etc., or any other suitable type of distance measuring sensor, which is mainly used to measure the distance between the object in the space and the sensing device.

Further preferably, the housing 1 further includes a first cover plate 11, which includes a first opening 101 through which the camera and the distance measuring sensor can be arranged to be exposed to the space. Furthermore, for the purposes of aesthetics and protection, the first cover plate 11 may be provided with a film covering, a transparent material covering, a protective layer, etc., which will not be described in detail here.

Further preferably, the housing 1 also includes a second cover plate 12, which is arranged opposite to the first cover plate and has a hollow threaded pipe 120 extending to the outside of the housing. The hollow threaded pipe 120, for example, may be used for screwing into a corresponding threaded hole in the ceiling of the space so as to fix the sensing device. Moreover, cables of various means inside the sensing device can be led out through the hollow threaded pipe to obtain power or transmit signals.

Further preferably, the sensing device also comprises a fill level adjustment switch (not specifically shown) which is arranged to be exposed through a second opening 102 on the housing 1, and the fill level adjustment switch is communicatively connected with the controller. Preferably, the second opening 102 may be arranged on a side wall of the housing 1 (as shown in the figure) or on the first cover plate, as long as it is convenient for operators' access. Further preferably, the sensing device may include a sliding cover 103 to slidably cover or open the second opening 102.

The fill level adjustment switch can be any suitable input device, such as a knob, a dial switch and the like, which is suitable for setting an alarm threshold for the fill level (for example, 70% or 80% of the full-loading level) and inputting the alarm threshold to the controller, so that the controller can calculate the current fill level through the method of the present disclosure (described in detail later) and compare the same with the alarm threshold, and when the alarm threshold is exceeded, an alarm indicating that the space is fully loaded can be sent out. It should be understood that the controller can be any suitable computing device, such as an MCU or the like.

A typical application of the sensing device according to the present disclosure is to sense the fill level in an elevator car. Therefore, the present disclosure also provides an elevator, which comprises the sensing device mentioned above for sensing the fill level of the elevator car space.

When applying the sensing device, the sensing device can be centrally installed on the ceiling of the elevator car, so that the camera 2 and the distance measuring sensor 3 face the ground of the elevator car, thereby obtaining the image of the car ground and measuring the distance from the objects in the car.

Preferably, the elevator can also include an elevator car control box 4, which is not only used to control various behaviors and equipment of the elevator, but also used to receive the sensing signals from the sensing device, and then send the sensing signals to an elevator control carbinet 6 or other data centers through wireless or wire transmission 7. The elevator car control box 4 can also supply power to the sensing device.

In addition, in the case that an elevator car control box of a certain elevator is not suitable for directly receiving sensing signals, a sensing device control box 5 can be additionally provided, which includes a power supply for supplying power to the sensing device (this power supply can also obtain power from the elevator car control box 4) and a means for receiving and forwarding the sensing signals from the sensing device to the elevator car control box 4 (such as any suitable data receiving/forwarding means, etc.).

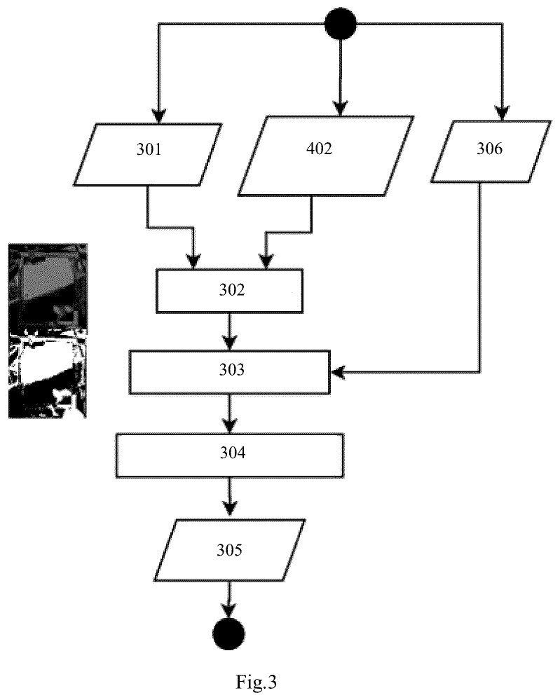

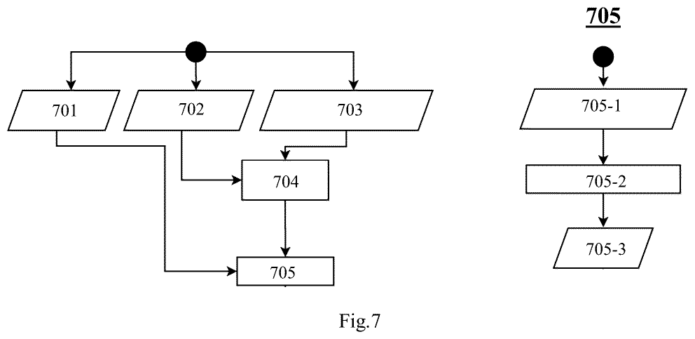

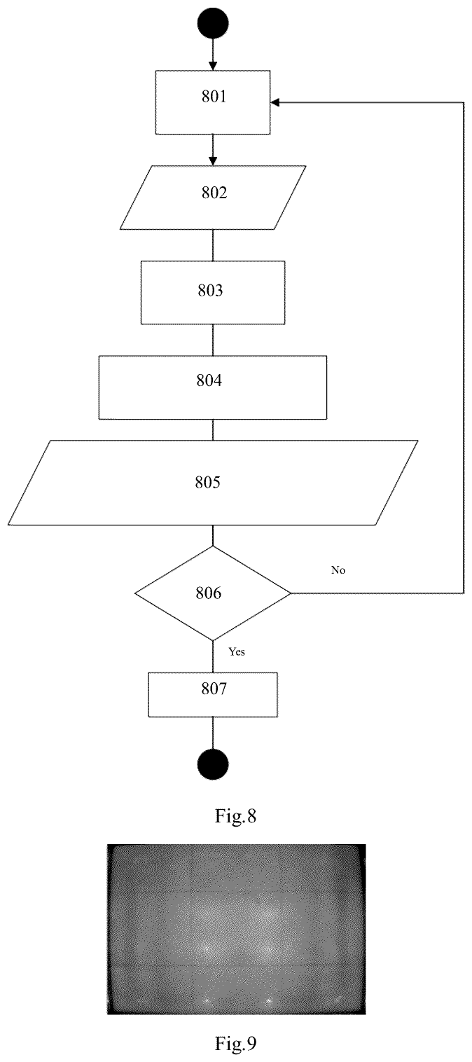

With reference to FIGS. 3-8, a method for sensing the fill level of a space (especially the elevator car space) according to the preferred embodiment of the present disclosure will be described below, which mainly comprises:
step S1, obtaining a real-time ground image of the current space (301); the real-time ground image contains all objects in the current space, so that the method of the present disclosure can determine the fill level according to these real-time ground image.
step S2, comparing the real-time ground image with a ground reference image, and calculating an image difference between the real-time ground image and the ground reference image (302); it should be understood that the ground reference image is an image of an “empty” ground obtained when there is no object on the ground, which can be obtained by any suitable method, for example, any suitable picture can be taken for the space, and then stored as a ground reference image after appropriate processing. And the ground reference image can be called or input to the controller (402) of the sensing device at the same time as the real-time ground image is input. Herein after, the present disclosure provides a preferred method for initializing the ground reference image.
Step S3: converting the image difference into a binary image (303), and calculating ratios of specified pixels (such as white pixels or black pixels) to all the ground pixels in the binary image (304).
Step S4: outputting the fill level of the space corresponding to the ratios (305). The output fill level of the space may be used to compare with the alarm threshold of the fill level as mentioned above, so that when the fill level of the space obtained by the above method exceeds the alarm threshold, the controller sends out an alarm signal or the like.

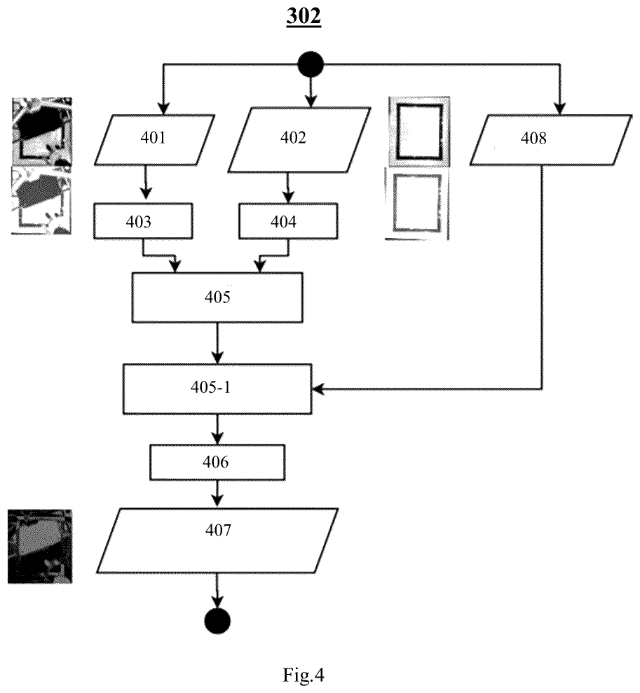

Further preferably, the method for obtaining the image difference is further optimized since the space, such as the elevator car, needs a faster and more accurate fill level determination and response. Specifically, referring to FIG. 4, the above step S2 (i.e., block 302) may further comprise:
after inputting the real-time ground image (401) and the ground reference image (402), performing YUV conversion (403) on the real-time ground image and YUV conversion (404) on the ground reference image, and calculating an absolute difference between the three YUV color channels of the real-time ground image and the ground reference image (405);
subsequently, the absolute difference of the three color channels being integrated into an absolute difference of a single channel (406) to output the absolute difference of the single channel as the image difference (407).

The present disclosure preferably make the image subjected to YUV conversion as described above, so that a faster image processing response and a real-time determination of the fill level can be realized.

In addition, in order to make the processing result of the color channels more reasonable and accurate, step S2 may further comprise:
applying a color channel weight to each color channel (408) to process the absolute difference between each color channel according to the color channel weight, to obtain a more reasonable absolute difference (405-1). For example, a color channel weight parameter may be input at the same time as the real-time ground image and the ground reference image are input. The color channel weight parameter may be obtained according to actual situation, historical experience or optimization algorithm, etc. According to the research of the inventors of this invention, the color channel weight parameter is set as: DIFF_CHANNEL_WEIGHTS=(0.2, 0.4, 0.4), and the absolute difference of each color channel may be specially optimized, so that the result is in line with the requirement and more accurate.

Referring back to FIG. 3, according to the present disclosure, step S3 may further comprise inputting a screening threshold (306), to further screen the binary image of the image difference obtained from step 302 according to the screening threshold, so as to obtain a more accurate binary image of the image difference. The screening threshold can be obtained according to actual needs, historical experience or optimization algorithm etc.

In addition, according to the present disclosure, step S3 further comprises: obtaining a distance between an object in the space and the distance measuring sensor from the distance measuring sensor installed at the top of the space; if the distance exceeds a predetermined distance range, step S4 will not be performed. For example, for an elevator car space, distance measurement result of TOF sensor may be obtained from the sensing device installed at the top of the elevator car as mentioned above. If the distance measurement result shows that the object in the elevator car is too close to the sensing device (for example, less than 10 cm), it indicates that the field of vision of the sensing device may have been blocked by the object (for example, the object may be an umbrella held by an occupant). At this time, the so-called ground image obtained from the camera will not indicate the true loading status on the ground, and even if the fill level is calculated, it has no practical significance, so the output of the fill level calculation result can be stopped. On the other hand, if the distance measurement results show that the object is very close to the ground (for example, less than 20 cm), it indicates that the object may be an object such as a thin plate placed flat on the ground. Although it may occupy most of the ground, it may not prevent the elevator from further loading other objects, so the output of the fill level calculation results may also be stopped.

As mentioned above, the ground reference image can be obtained by various methods, and the present disclosure provides an optimized initialization method for the ground reference image.

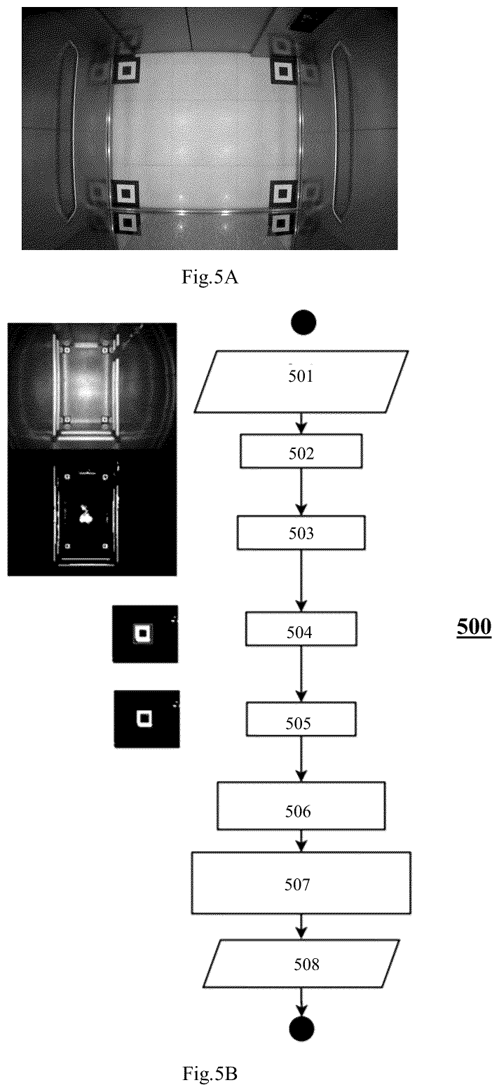

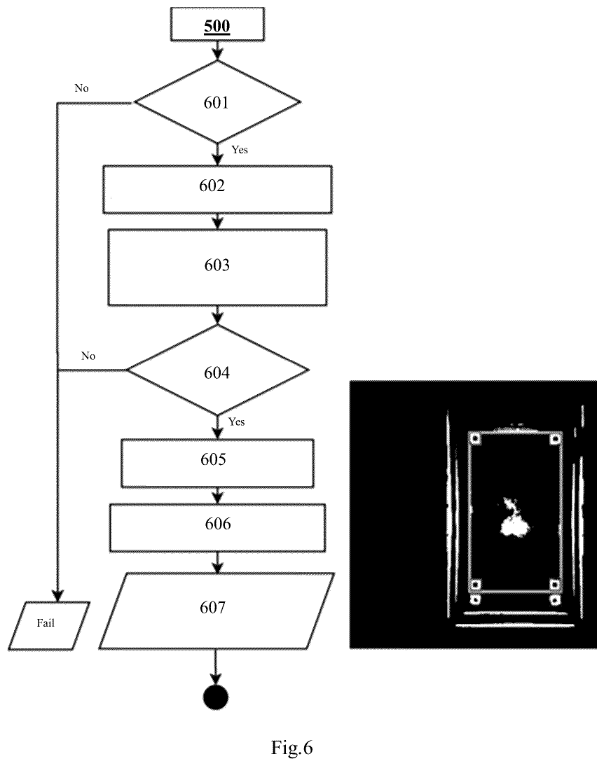

Specifically, referring to FIGS. 5A-5B, the initialization process for the ground reference image comprises:
step I1: setting markers at a plurality of characteristic positions on the ground (501). For example, if the elevator car has a rectangular ground shape, square blocks can be set at four corners (i.e. rectangular characteristic positions) of the rectangular ground, and each square block includes a black frame at the periphery, a black square in the center, and a white frame between the black frame and the black square, as shown in FIG. 5A. Of course, if the ground has another shape, suitable markers may be set at characteristic positions of this special shape.

Subsequently, images of the markers are obtained (for example, through the camera of the sensing device as mentioned above), and qualified markers that meet a criteria are screened out and identified. The “criteria” herein is set according to actual needs, processing needs and/or historical experience, so as to process and screen out the images of the markers to identify the correct marker images. For example, for the markers shown in FIG. 5A, images of square blocks can be obtained, and an image, that conforms with the positional relationship and the specified ratio between the black frame and the white frame, can be screened out from the images of the square blocks to identify each marker. This may specifically include: converting the image into a grayscale image (502), setting an appropriate threshold for preliminary screening (503), finding out the white frame (504), finding out the black frame (505), finding out the black frame within the white frame (506), selecting a frame with the correct ratio between the black frame and the white frame (507), and outputting the selected marker (508). Through this process, the influence of the virtual image of the markers caused by reflection on the side walls of the car can be eliminated, and the incorrect markers can be excluded, but to identify and keep the correct markers.
step 12: processing the identified markers to obtain a binary ground mask and a ground mask contour that conforms with the actual shape of the ground. This may comprise, for example:
determining whether the identified markers meet the specified quantity? (601), if yes, the proceed to the next step, otherwise, determine that the initialization is failed; for example, for the rectangular ground of the elevator car in the above example, the quantity of the identified markers should be at least 4;
using the identified markers to generate a shape conforming with the ground (602); for the ground of the elevator car, rectangle is the shape best conforming with the ground, so the four identified markers should be used as corners to generate rectangular ground contours;
removing the unqualified shape that does not meet the criteria, for example, for the rectangle generated previously, such generated rectangular ground contours can be screened at least according to aspect ratio, flatness and/or distance from the geometric center of the shape, so as to reserve the qualified rectangular ground contours that meet the criteria (603);
determining whether there are qualified rectangular ground contours being reserved (604)? If yes, then proceed to the next step, otherwise, it is determined that the initialization is failed;
further screening the reserved rectangular ground contours based on the size and proximity to the image center (605);
selecting an optimal ground contour as the ground mask contour for the elevator car (606);
outputting a binary ground mask and the ground mask contour conforming with the actual shape of the ground (607).
step 13: obtaining a ground verification image, and obtaining a corrected ground mask image in accordance with the binary ground mask and the ground mask contour, which may include, for example:
inputting the binary ground mask (701), inputting the ground verification image (702, for example, obtained by the camera of the sensing device), and inputting the ground mask contour conforming with the actual shape of the ground as mentioned above (703);
as a preferred step, correcting the input images to reduce the size (704);
correcting the ground verification image according to ground mask contour (705-1),
performing a logical AND operation on the corrected ground verification image and the binary ground mask (705-2);
obtaining and outputting the corrected ground mask image (705-3).
step I4: obtaining a ground image without markers, and correcting the ground image without markers according to the corrected ground mask image to obtain a ground reference image. This may include, for example:
obtaining a ground image without markers (801), for example, including obtaining multiple groups of current ground images without makers, each group containing a plurality of current ground images without makers (for example, 20 images in each group, and a total of 2 groups), and setting an image cache according to the number of groups and the number of images in each group;
inputting the current ground images (802);
correcting each current ground image without makers according to the corrected ground mask image, and converting the corrected current ground image into a binary image (803);
preferably, inputting such converted binary images input to corresponding image caches, and old images in the cache being replaced with new images (804);
averaging all the binary images to obtain an average value, and screening out a binary image having the smallest image difference according to the average value (805);
determining whether all the image caches are full? (806) If yes, proceed to the next step, otherwise, return to block 801;
taking the corrected current ground image corresponding to the binary image having the smallest image difference as the ground reference image (807), such generated ground reference image being shown in FIG. 9.

It should be understood that the above method can be stored in the sensing device controller as mentioned above by programming or other methods and executed by the controller. The ground reference image can be obtained when the sensing device is initialized, so as to be used in subsequent real-time fill level determination; or the ground reference image is updated according to the above method when necessary.

To sum up, the present disclosure provides a method for determining the fill level of a space like an elevator car without utilizing the gravity load, and the method can better identify the objects in the space and further calculate the fill level of the space according to the identified images, and can be used as a substitute or a beneficial supplement for gravity load determination.

The exemplary implementation of the present disclosure has been described in detail above with reference to the preferable embodiments. However, it can be understood by those skilled in the art that without departing from the concept of the present disclosure, various changes and modifications can be made to the above specific embodiments, and various technical features and structures provided in this disclosure can be combined in various ways without going beyond the protection scope of the present disclosure, which is determined by the appended claims.

1. A sensor for sensing a fill level of a space, comprising:
a housing;
a circuit board, provided in the housing;
a camera, connecting to the circuit board; and
a distance measuring sensor, connecting to the circuit board,
wherein a controller is provided on the circuit board and is in communication connection with the camera and the distance measuring sensor to calculate the fill level of the space according to an input from the camera and the distance measuring sensor, and
wherein the camera and the distance measuring sensor are arranged to be exposed to the space.

2. The sensor according to claim 1, wherein the housing further comprises a first cover plate including a first opening, through which the camera and the distance measuring sensor are arranged to be exposed to the space.

3. The sensor according to claim 2, wherein the housing further comprises a second cover plate, the second cover plate being arranged opposite to the first cover plate and having a hollow threaded pipe extending to the outside of the housing.

4. The sensor according to claim 1, further comprising a fill level adjustment switch, is the fill level adjustment switch being arranged to be exposed through the second opening on the housing and being communicatively connected with the controller.

5. The sensor according to claim 4, further comprising a sliding cover to slidably cover or open the second opening.

6. The sensor according to claim 5, wherein the second opening is provided on the side wall of the housing or on the first cover.

7. An elevator, comprising the sensor according to claim 1 for sensing the fill level of the elevator car space.

8. The elevator according to claim 7, wherein the sensor is centrally installed on the ceiling of the elevator car so that the camera and the distance measuring sensor face the floor of the elevator car.

9. The elevator according to claim 7, further comprising an elevator car control box for receiving and forwarding sensing signals from the sensing device.

10. The elevator according to claim 7, further comprising:
an elevator car control box; and
a sensor control box, including a power supply for supplying power to the sensor and a means for receiving and forwarding the sensing signals from the sensor to the elevator car control box.

11. A method for sensing a fill level of a space, comprising:
obtaining a real-time ground image of the current space through a camera;
comparing the real-time ground image with a ground reference image, and calculating the image difference between the real-time ground image and the ground reference image;
converting the image difference into a binary image, and calculating ratios of specified pixels to all ground pixels in the binary image; and
outputting a fill level of the space corresponding to the ratios.

12. The method of claim 11, further comprising an initialization process for the ground reference image, comprising:
setting markers at a plurality of characteristic positions on the ground, obtaining images of the markers, and screening out and identifying qualified markers that meet a criteria;
processing the identified markers to obtain a binary ground mask and a ground mask contour that conforms with an actual shape of the ground;
obtaining a ground verification image, and obtaining a corrected ground mask image in accordance with the binary ground mask and the ground mask contour; and
obtaining a ground image without markers, and correcting the ground image without markers according to the corrected ground mask image, to obtain a ground reference image.

13. The method of claim 12, wherein the ground has a rectangular shape, and the step of setting markers further comprises:
setting square blocks on the characteristic positions at four corners of the rectangular ground, wherein each of the square blocks comprises a black frame at a peripheral thereof, a black square in a center thereof, and a white frame between the black frame and the black square; and
obtaining the images of the square blocks, and screening out, from the images of the square blocks, an image that conforms with a positional relationship and a specified ratio between the black frame and the white frame, so as to identify each marker.

14. The method of claim 13, wherein said step of processing the identified markers further comprises:
generating rectangular ground contours by taking the identified markers as corners;
screening the rectangular ground contours, to reserve the qualified rectangular ground contours that meet the criteria, at least according to a aspect ratio, a flatness and/or a distance from a geometric center of the shape;
further screening the reserved rectangular ground contours based on a size and proximity to the image center; and
selecting an optimal ground contour as the ground mask contour.

15. The method of claim 14, wherein the step of obtaining a ground verification image further comprises:
correcting the ground verification image according to the ground mask contour; and
performing a logical AND operation on the corrected ground verification image and the binary ground mask, to obtain and output the corrected ground mask image.

16. The method of claim 15, wherein the step of obtaining a ground image without markers further comprises:
obtaining multiple groups of current ground images without makers, wherein each group contains a plurality of current ground images without makers;
correcting each current ground images without makers according to the corrected ground mask image, and converting the corrected current ground image into a binary image;
averaging all the binary images to obtain an average value, and screening out a binary image having the smallest image difference according to the average value; and
taking the corrected current ground image corresponding to the binary image having the smallest image difference as the ground reference image.

17. The method of claim 11, wherein the step comparing the real-time ground image with a ground reference image further comprises:
performing YUV conversion on the real-time ground image and the ground reference image, and calculating an absolute difference between the three YUV color channels of the real-time ground image and the ground reference image; and
integrating the absolute difference of the three color channels into an absolute difference of a single channel, to output the absolute difference of the single channel as the image difference;

18. The method of claim 17, wherein the step of comparing the real-time ground image with a ground reference image further comprises:
applying a color channel weight to each color channel to process the absolute difference between each color channel according to the color channel weight, so as to obtain more a reasonable absolute difference.

19. The method of claim 11, wherein the step of converting the image difference into a binary image further comprises:
inputting a screening threshold to further screen the binary image according to the screening threshold.

20. The method of claim 11, wherein the step gf converting the image difference into a binary image further comprises:
obtaining a distance between an object in the space and a distance measuring sensor from a distance measuring sensor installed at a top of the space; and
if the distance exceeds a predetermined distance range, the step of outputting a fill level of the space corresponding to the ratios will not be performed.
